(19) United States
(12) Patent Application Publication
(10) Pub. No.: US 2025/0246618 A1
(43) Pub. Date: Jul. 31, 2025

(54) DOPED AND COATED NICKEL-RICH CATHODE ACTIVE MATERIALS AND METHODS THEREOF

(71) Applicant: Tesla, Inc., Austin, TX (US)

(72) Inventors: Andrew Phillip Ulvestad, Oakland, CA (US); Sanketh Gowda, Fremont, CA (US); Vineet Haresh Mehta, Mountain View, CA (US); Jesse Steven Wilson, San Jose, CA (US)

(21) Appl. No.: 18/726,270

(22) PCT Filed: Jan. 4, 2023
(86) PCT No.: PCT/US2023/010105

§ 371 Date: Jul. 2, 2024

Related U.S. Application Data
(60) Provisional application No. 63/266,506, filed on Jan. 6, 2022.

(51) Int. Cl. H01M 4/525; C01G 53/42; H01M 4/36

(52) U.S. Cl. CPC H01M 4/525; C01G 53/42; H01M 4/366; C01P 2002/52; C01P 2002/70; C01P 2004/80; C01P 2006/40

(57) ABSTRACT

Doped and coated nickel-rich cathode active materials, and methods of manufacture, are described. The doped and coated nickel-rich cathode active materials enable energy storage devices with improved performances, including but not limited to improved energy densities and capacity retention.

### CROSS-REFERENCE TO RELATED APPLICATION

This application claims the benefit of U.S. Provisional Application No. 63/266,506, entitled DOPED AND COATED NICKEL-RICH CATHODE ACTIVE MATERIALS AND METHODS THEREOF, filed on Jan. 6, 2022, and which is incorporated by reference herein in its entirety.

### BACKGROUND

### Field

The present disclosure relates generally to energy storage devices, and specifically to cathode active materials for lithium-ion batteries and processes for forming the same.

### Description of the Related Art

Electrochemical energy storage systems are widely used to provide power to electronic, electromechanical, electrochemical, and other useful devices. Lithium-ion batteries are one of the most common examples of electrochemical energy storage systems, and the prevalence of lithium-ion batteries is due to their higher energy density when compared to other electrochemical energy storage systems. During the last decade, the use of lithium-ion batteries has expanded from consumer electronics to other areas including the automotive industry. A lithium-ion battery consists of four main components: a cathode electrode, anode electrode, electrolyte, and separator, and at least some of the success of lithium-ion batteries may be attributed to the development of high-energy density electrodes.

Presently, there are a small number of cathode active materials which are known or have been investigated for use in cathode electrodes for lithium-ion batteries, for example in the automotive industry. Examples of cathode active materials include transition metal layered oxides belonging to the LiNiO₂ (LNO), LiNi_{1-x-y}CoₓAl_{y}O₂ (NCA) or LiNi_{1-x-y}CoₓMn_{y}O₂ (NCM or NMC) families. These nickel-rich cathode active materials can provide the high energy densities in part because of their high nickel content. Although these nickel-rich cathode active materials have shown significant promise they also have their drawbacks including a significant loss of charge capacity over repeated charge/discharge cycles. Accordingly, there is a need for the development of improved nickel-rich cathode active materials.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

In a first aspect, a doped nickel-rich cathode active material is provided. The doped nickel-rich cathode active material includes the chemical formula LiNiₐTm_{b}M_{c}O₂, where Tm is a transition metal element, M is a dopant element, a is a value of at least 0.9, b is a value from 0.01 to 0.0995, and c is a value from 0.005 to 0.02.

In some embodiments, the dopant element is selected from the group consisting of Ca, Mg, Zr, and combinations thereof. In some embodiments, the dopant element is Zr and another element selected from the group consisting of Ca, Mg, and combinations thereof. In some embodiments, the compound comprises an atomic amount of Zr of at least about 0.003. In some embodiments, the transition metal element is selected from the group consisting of Al, Zr, Mn, Ti, Co, and combinations thereof. In some embodiments, the transition metal element includes Al, where x is a value from 0.01 to 0.03. In some embodiments, the transition metal element includes Mn_{y}Co_{z}, where y is a value from 0 to 0.05, where z is a value from 0 to 0.05. In some embodiments, the transition metal element includes AlₓMn_{y}Co_{z}, where x is a value from 0.01 to 0.03, where y is a value from 0.01 to 0.05, where z is a value from 0.01 to 0.05. In some embodiments, the nickel-rich cathode active material further includes a coating material disposed over the nickel-rich cathode active material. In some embodiments, the coating material is selected from the group consisting of a sulfur compound, a metal compound, and combinations thereof.

In some embodiments, an electrode film includes the doped nickel-rich cathode active material is provided. In some embodiments, the electrode film is disposed over a current collector forming a nickel-rich cathode electrode. In some embodiments, an energy storage device includes the nickel-rich cathode electrode, a separator, an anode electrode, an electrolyte, and a housing, where the nickel-rich cathode electrode, the separator, and the anode electrode are positioned within the housing. In some embodiments, the energy storage device is a battery.

In a second aspect, a coated nickel-rich cathode active material is provided. The coated nickel-rich cathode active material includes a nickel-rich cathode active material and a sulfur coating disposed over the nickel-rich cathode active material.

In some embodiments, the coated nickel-rich cathode active material further includes a metal coating. In some embodiments, the sulfur coating includes a compound selected from the group of dimethyl sulfone, dimethyl sulfoxide, sulfur nanoparticles, sodium dodecyl sulfate, sodium sulfate, lithium sulfate, and combinations thereof. In some embodiments, the metal coating includes an element selected from the group consisting of Al, W, Mo, and combinations thereof. In some embodiments, the coating includes a plurality of coating layers. In some embodiments, the nickel-rich cathode active material further includes a dopant element.

In third aspect, a method for preparing a doped nickel-rich cathode active material is provided. The method includes mixing a nickel-rich precursor with a dopant material, and a lithium source, to form a lithiated nickel-rich precursor mixture, and heating the lithiated nickel-rich precursor mixture to form a doped nickel-rich cathode active material.

In some embodiments, the method further includes disposing a sulfur coating material over the doped nickel-rich cathode active material. [0013] In a fourth aspect, a method for preparing a coated nickel-rich cathode active material is provided. The method includes mixing a nickel-rich cathode active material with a sulfur coating material to form a nickel-rich cathode active material mixture, where the sulfur coating material is disposed over the nickel-rich cathode active material, and heating the nickel-rich cathode active material mixture to form a coated nickel-rich cathode active material.

In some embodiments, the nickel-rich cathode active material further includes a dopant element.

All of these embodiments are intended to be within the scope of the invention disclosed herein. These and other embodiments will become readily apparent to those skilled in the art from the following detailed description of the preferred embodiments having reference to the attached figures, the invention not being limited to any particular preferred embodiment(s) disclosed.

### BRIEF DESCRIPTION OF THE DRAWINGS

FIG. 1 is a schematic depicting a process of forming a doped nickel-rich cathode active material, according to some embodiments.

FIG. 2 is a schematic depicting a process for forming a coated nickel-rich cathode active material, according to some embodiments.

FIG. 3 is an XRD pattern plot of a nickel-rich cathode active material, according to some embodiments.

FIG. 4 is a plot showing the impact of doping a nickel-rich cathode active material with calcium on the normalized discharge capacity of a half cell, according to some embodiments.

FIG. 5 is a plot showing the impact of doping a nickel-rich cathode active material with calcium on the normalized discharge energy of a full cell, according to some embodiments.

FIG. 6 is a plot showing the impact of coating a nickel-rich cathode active material with sulfur on the normalized discharge capacity of a half cell, according to some embodiments.

FIG. 7 is a plot showing the impact of coating a nickel-rich cathode active material with sulfur on the normalized cathode discharge energy of a full cell, according to some embodiments.

FIG. 8A is a plot showing the impact of coating a nickel-rich cathode active materials with a metal on the normalized discharge capacity of a half cell, according to some embodiments.

FIG. 8B is a plot showing the impact of coating a nickel-rich cathode active materials with a metal on the average charge voltage-average discharge voltage of a half cell, according to some embodiments.

FIG. 9 is a plot showing the impact of coating a calcium doped nickel-rich cathode active material with sulfur on the normalized discharge capacity of a half cell, according to some embodiments.

FIG. 10 is a plot showing the impact of coating a calcium doped cathode active material with sulfur on the normalized cathode energy of a full cell, according to some embodiments.

FIG. 11A is a plot showing the impact of including various transition metals within the nickel-rich cathode active material on the normalized discharge capacity of a half cell, according to some embodiments.

FIG. 11B is a plot showing the impact of including various transition metals within the nickel-rich cathode active material on the charge voltage-discharge voltage of a half cell, according to some embodiments.

FIG. 12 is a plot showing the impact of including various transition metals within the nickel-rich cathode active material on the normalized cathode energy of a full cell, according to some embodiments.

### DETAILED DESCRIPTION

Provided herein are various embodiments of a nickel-rich cathode active material with improved discharge capacity and capacity retention, and methods for preparing the nickel-rich cathode active materials. Such nickel-rich cathode active materials may be doped and/or coated to reduce 1) mixing of lithium and nickel atoms within the crystal lattice and 2) oxygen mobility or evolution at the cathode electrode surface during cycling. As such, the improved nickel-rich cathode active materials described herein may be used to reduce electrical resistance and improve cycle lifetimes in energy storage devices.

In certain embodiments, the nickel-rich cathode active materials are of the general formula LiNiₐO₂ or LiNiₐTm_{b}O₂, wherein “a” is at least, or is at least about, 0.8 and “Tm” is at least one transition metal element. For example, such nickel-rich cathode active materials include LiNi_{1-x-y}CoₓAl_{y}O₂ (“NCA”) and LiNi_{1-x-y}CoₓMn_{y}O₂ (“NCM”).

In certain embodiments, the nickel-rich cathode active material may include a dopant material. In some embodiments, the dopant material is selected from a metal (M), metal oxide (M_{y}O_{z}), a metal hydroxide (M_{y}(OH)_{z}), and combinations thereof, wherein “M” represents a metal and “y” and “z” are values which create a neutrally charged dopant material. In some embodiments, the dopant material comprises a metal (“M”) selected from calcium (Ca), magnesium (Mg), zirconium (Zr), and combinations thereof. In some embodiments, the dopant material comprises Zr and a metal selected from calcium (Ca), magnesium (Mg), and combinations thereof.

In certain embodiments, the nickel-rich cathode active material may include a coating material. In some embodiments, the coating material includes a sulfur compound, a metal compound, or combinations thereof. In some embodiments, the sulfur compound is selected from dimethyl sulfone (DMS), dimethyl sulfoxide (DMSO), and combinations thereof. In some embodiments, the metal compound comprises a metal selected from tungsten (W), molybdenum (Mo), aluminum (Al), and combinations thereof.

In some embodiments, the nickel-rich cathode active material may include a dopant material and a coating material. Such doped and coated nickel-rich cathode active materials are described and may be prepared by the processes described herein.

### Doped Nickel-Rich Cathode Active Material and Processes Thereof

Cathode active materials with high nickel content (“nickel-rich”) may include a dopant to improve the performance of cathode electrodes. In some embodiments, nickel-rich cathode active material comprises lithium (Li), nickel (Ni), a dopant element (M), and oxygen (O). In some embodiments, the nickel-rich cathode active material further comprises a transition metal element (Tm). In some embodiments, the nickel-rich cathode active material may include LiNiₐZ_{c}O₂, LiNiₐTm_{b}Z_{c}O₂, or combinations thereof. In some embodiments, the nickel-rich cathode active material may include LiNiₐM_{c}O₂, LiNiₐTm_{b}M_{c}O₂, or combinations thereof. In some embodiments, “a” is, is about, is at least, or is at least about, 0.7, 0.75, 0.8, 0.85, 0.9, 0.92, 0.95, 0.98 or 0.99, or any range of values therebetween. For example, in some embodiments, “a” is a numerical value between 0.7 and 0.99, between 0.85 and 0.95, or between 0.9 and 0.99. In some embodiments, the transition metal element (“Tm”) is selected from aluminum (Al), manganese (Mn), titanium (Ti), cobalt (Co), zirconium (Zr), and combinations thereof. In some embodiments, the transition metal element (“Tm”) is selected from aluminum (Al), manganese (Mn), titanium (Ti), cobalt (Co), and combinations thereof. In some embodiments, the transition metal element comprises Mn_{y}Co_{z}, wherein y is a value from 0.01 to 0.05 or 0 to 0.05, and/or wherein z is a value from 0.01 to 0.05 or 0 to 0.05. In some embodiments, when y is 0 z is greater than 0 (e.g., 0.01). In some embodiments, when z is 0 y is greater than 0 (e.g., 0.01). In some embodiments, the transition metal element comprises AlₓMn_{y}Co_{z}, wherein x is a value from 0.01 to 0.03, wherein y is a value from 0.01 to 0.05, wherein z is a value from 0.01 to 0.05. In some embodiments, “b” is, or is about, 0, 0.001, 0.005, 0.01, 0.02, 0.03, 0.04, 0.05, 0.06, 0.07, 0.08, 0.09, 0.0995, 0.1, or any range of values therebetween. For example, in some embodiments, “b” is a numerical value from 0.001 to 0.1, from 0.001 to 0.05, or from 0.001 to 0.03. In some embodiments, each element of Tm is, or is about, 0, 0.01, 0.02, 0.03, 0.04, 0.05, 0.06, 0.07, 0.08, 0.09, 0.0995 or 0.1 mol % of the nickel-rich cathode active material, or any range of values therebetween. In some embodiments, the dopant element (“Z”) includes a metal (“M”). In some embodiments, the metal (“M”) is selected from calcium (Ca), magnesium (Mg), zirconium (Zr) and combinations thereof. In some embodiments, the dopant element (e.g., metal) comprises Zr and a metal selected from calcium (Ca), magnesium (Mg), and combinations thereof. In some embodiments, “c” is, or is about, 0.005, 0.01, 0.015, 0.02, 0.025, 0.04, 0.06, 0.08, 0.1, or any range of values therebetween. For example, in some embodiments, “c” is a numerical value between 0.005 and 0.1, between 0.005 and 0.025, or between 0.005 and 0.01. In some embodiments, the nickel-rich cathode active material may include an atomic amount of Zr of, of about, of at least, or at least about, 0.002, 0.003, 0.004, 0.005, 0.006, 0.007, 0.008, or any range of values therebetween.

In some embodiments, the nickel-rich cathode active material may have a formula of LiₐNi_{b}Al_{c}Ca_{d}ZrₑO₂. In some embodiments, “a” is, or is about, 0.97, 0.975, 0.98, 0.99, 0.995, 1 or any range of values therebetween. For example, in some embodiments, “a” is a numerical value of or between 0.97 to 1, 0.98 to 1, or 0.99 to 1. In some embodiments, “b” is, or is about, 0.95, 0.955, 0.96, 0.965, 0.97, 0.975, 0.98 or any range of values therebetween. For example, in some embodiments, “b” is a numerical value of or between 0.95 to 0.98, 0.96 to 0.97, or 0.96 to 0.98. In some embodiments, “c” is, or is about, 0.001, 0.0015, 0.002, 0.0025, 0.003, or any range of values therebetween. For example, in some embodiments, “c” is a numerical value of or between 0.001 to 0.003, 0.0015 to 0.0025, or 0.0015 to 0.003. In some embodiments, “d” is, or is about, 0.001, 0.0015, 0.002, 0.0025, 0.003, 0.0035, 0.004, or any range of values therebetween. For example, in some embodiments, “d” is a numerical value of or between 0.001 to 0.004, 0.0015 to 0.004, or 0.0015 to 0.0035. In some embodiments, “e” is, is about, at least, or at least about 0.002, 0.003, 0.004, 0.005, 0.006, 0.007, 0.008, or any range of values therebetween. For example, in some embodiments, “e” is a numerical value of or between 0.002 to 0.008, 0.003 to 0.008, or 0.003 to 0.007. In some embodiments, the nickel-rich cathode active material has a formula of LiₐNi_{b}Al_{c}Ca_{d}Zr_{c}O₂, wherein a is from about 0.99 to about 1, b is from about 0.96 to about 0.97, c is from about 0.015 to about 0.025, d is from about 0.0015 to about 0.0035, e is from about 0.003 to about 0.007. In some embodiments, the nickel-rich cathode active material has a formula of, or of about, LiNi_{0.965}Al_{0.02}Ca_{0.0025}Zr_{0.005}O₂.

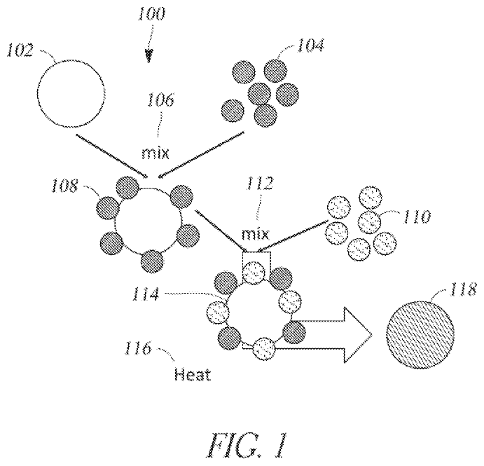

Nickel-rich precursor materials, nickel-rich precursor mixtures, and lithiated nickel-rich precursor mixtures are processed to form doped nickel-rich cathode active materials. FIG. 1 is a flow chart 100 illustrating an example of the doped nickel-rich cathode active material formation process according to some of the embodiments. A nickel-rich precursor 102 and a dopant material 104 are provided and combined (e.g., mixed) in processing step 106 to form a nickel-rich precursor mixture 108. The nickel-rich precursor mixture 108 is combined (e.g., mixed) in processing step 12 with a lithium source 110 to form a lithiated nickel-rich precursor mixture 114. The lithiated nickel-rich precursor mixture 114 is heated (e.g., high temperature calcination) in processing step 116 to form the doped nickel-rich cathode active material 118. Although FIG. 1 depicts processing step 106 occurring prior to processing step 108, it is understood that the processing steps may be carried out simultaneously, or processing step 106 may occur subsequent to processing step 108.

In some embodiments, the nickel-rich precursor is an oxide, hydroxide, or combinations thereof. In some embodiments, the nickel-rich precursor comprises a transition metal element (“Tm”) selected from aluminum (Al), manganese (Mn), titanium (Ti), cobalt (Co), zirconium (Zr) and combinations thereof. In some embodiments, the nickel-rich precursor is selected from NiAl(OH)₂, NiMnAl(OH)₂, NiMnCo(OH)₂, NiCoAl(OH)₂, NiZr(OH)₂, and combinations thereof.

In some embodiments, the dopant material is selected from a metal (M), metal oxide (M_{y}Oz), a metal hydroxide (My(OH)_{z}), and combinations thereof, wherein “M” represents a metal and “y” and “z” are values which create a neutrally charged dopant material. In some embodiments, the dopant material comprises a metal (“M”) selected from calcium (Ca), magnesium (Mg), zirconium (Zr), and combinations thereof. In some embodiments, the dopant material is a metal hydroxide selected from Ca(OH)₂, Mg(OH)₂, and combinations thereof. In some embodiments, the dopant material is a metal oxide such as ZrO₂. In some embodiments, the nickel-rich precursor mixture comprises, or comprises about, 0.1 mol. %, 0.125 mol. %, 0.25 mol. %, 0.5 mol. %, 0.75 mol. %, 1 mol. %, or 1.5 mol. % of a dopant material, or any range of values therebetween. In some embodiments, the molar ratio of the nickel:dopant material in the nickel-rich precursor mixture is, or is about, 1:0.005, 1:0.01, 1:0.015, 1:0.02, 1:0.025, 1:0.03, 1:0.035, 1:0.04, 1:0.045 or 1:0.05, or any range of values therebetween.

A lithiated nickel-rich precursor mixture may comprise the nickel-rich precursor mixture and a lithium source. In some embodiments, the lithium source includes a lithium salt. In some embodiments, the lithium salt is selected from LiOH·H₂O, Li₂CO₃, and combinations thereof. In some embodiments, the molar ratio of the lithium:nickel in the lithiated nickel-rich precursor mixture is, or is about, 0.9:1, 0.95:1, 0.99:1, 1:1, 1.01:1, 1.05:1, or 1.1:1, or any range of values therebetween. In some embodiments, the nickel-rich active material mixture comprises, or comprises about, 10 wt. %, 11 wt. %, 12 wt. %, 14 wt. %, 16 wt. %, 18 wt. %, 20 wt. %, 25 wt. %, 30 wt. %, 35 wt. % or 40 wt. % of a lithium source, or any range of values therebetween.

In some embodiments, the lithiated nickel-rich precursor mixture is heated after being formed. In some embodiments, heating is performed at a temperature of, of about, of at least, or at least about, 550° C., 600° C., 625° C., 650° C., 675° C., 700° C., 725° C., 750° C., 760° C., 780° C., 800° C., 820° C., 840° C., 850° C., 860° C., 880° C., 900° C., 950° C. or 1000° C., or any range of values therebetween. In some embodiments, heating of the lithiated nickel-rich precursor mixture is performed in an oxidizing atmosphere, an inert atmosphere, or a reducing atmosphere. In some embodiments, an oxidizing atmosphere is an atmosphere comprising oxygen, for example such as air or an oxygen rich atmosphere. In some embodiments, an oxygen rich atmosphere comprises at least 21 vol % oxygen, at least 23.5 vol % oxygen or at least 25 vol % oxygen. In some embodiments, an inert atmosphere is an atmosphere comprising helium, neon, argon, krypton, xenon, radon, nitrogen, or combinations thereof. In some embodiments, a reducing atmosphere is an atmosphere comprising hydrogen, carbon monoxide, hydrogen sulfide, or combinations thereof. In some embodiments, heating is performed for a duration of, of about, of at least, or at least about, 0, 1, 2, 3, 4, 5, 7, 10, 20 or 50 hours, or any range of values therebetween. In some embodiments, the lithiated nickel-rich precursor mixture is calcinated when heated.

In some embodiments, the process further includes destructuring the doped nickel-rich cathode active material. In some embodiments, destructuring comprises a step selected from crushing, milling, and combinations thereof. In some embodiments, the process includes treating the doped nickel-rich cathode active material. In some embodiments, treating comprises a step selected from sieving, washing, filtering, drying, coating, and combinations thereof

### Coated Nickel-Rich Cathode Active Materials and Processes Thereof

Nickel-rich cathode active materials may include a coating to improve the performance of cathode electrodes. In some embodiments, the coating comprises a layer disposed over an outer surface of the cathode active material. In some embodiments, the coating comprises a plurality of coating elements disposed over an outer surface of the cathode active material. In some embodiments, the coating (e.g. layer and/or plurality of coating elements) partially, substantially, or completely covers the outer surface of the cathode active material. In some embodiments, the coating includes a plurality of coating layers, such as 1, 2, 3, 4, 5 coating layers, or any range of values therebetween. In some embodiments, the coating includes a sulfur compound, a metal compound, or combinations thereof. In some embodiments, the sulfur compound includes sulfur nanoparticles, a sulfur gel, a sulfur solution, or combinations thereof. In some embodiments, the sulfur compound includes (CH₃)₂SO, (CH₃)₂SO₂, NaCl₂H₂₅SO₄, or combinations thereof. In some embodiments, the metal compound includes an element selected from W, Mo, Al and combinations thereof. In some embodiments, the metal compound includes the compounds NH₄W, NH₄Mo, NaAlO₂, or combinations thereof. In some embodiments, the nickel-rich cathode active material is a doped nickel-rich cathode active material as described and prepared by the processes described herein.

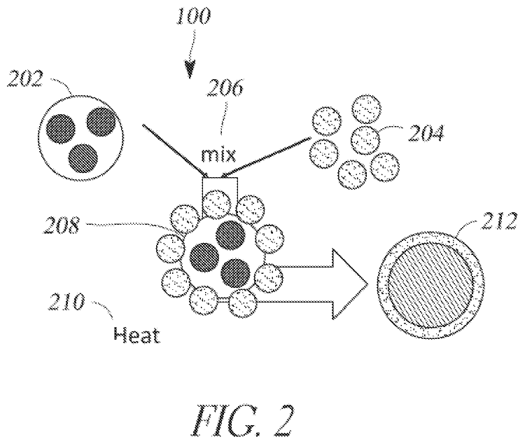

Nickel-rich cathode active materials and coating materials are processed to form coated nickel-rich cathode active materials. FIG. 2 is a flow chart 200 illustrating an example of the coated nickel-rich cathode active material formation process according to some of the embodiments. A nickel-rich cathode active material 202 and a coating material 204 are provided and combined (e.g., mixed) in processing step 206 to form a nickel-rich cathode active material mixture 208. The nickel-rich cathode active material mixture 208 is heated in processing step 210 to form the coated nickel-rich cathode active material 212.

In some embodiments, the coating material comprises a sulfur compound, a metal compound, or combinations thereof. In some embodiments, the metal compound comprises a metal selected from tungsten (W), molybdenum (Mo), aluminum (Al), and combinations thereof. In some embodiments, the aluminum coating material is selected from Al₂O₃, NaAlO₂, Al(OH)₃, and combinations thereof. In some embodiments, the tungsten coating material is selected from NH₄W, (NH₄)₁₀H₂(W₂O₇)₆, Na₂WO₄, WO₃, and combinations thereof. In some embodiments, the molybdenum compound is NH₄Mo. In some embodiments, the sulfur compound is selected from dimethyl sulfoxide (DMSO), dimethyl sulfone (DMS), sulfur nanoparticles, sodium dodecyl sulfate, sodium sulfate, lithium sulfate, and combinations thereof. In some embodiments, the coating material is added to the nickel-rich cathode active material at 0.01, 0.02, 0.04, 0.08, 0.1, 0.15, 0.20, 0.25, 0.30, 0.35, 0.40, 0.45, 0.50 or 0.60 mol. %, or any range of values therebetween.

In some embodiments, the nickel-rich cathode active material is washed with water prior to mixing with the coating material. In some embodiments, a solid-liquid separation is performed on the washed nickel-rich cathode active material prior to mixing with the coating material. In some embodiments, the nickel-rich cathode active material comprises, or comprises about, 1 wt. %, 2 wt. %, 3 wt. %, 5 wt. %, 7 wt. %, 9 wt. % or 12 wt. % water, or any range of values therebetween.

In some embodiments, the nickel-rich cathode active material mixture is heated after being formed. In some embodiments, heating is performed at a temperature of, of about, of at least, or at least about, 100° C., 125° C., 150° C., 175° C., 200° C., 225° C., 250° C., 275° C., 300° C., 325° C., or 350° C., or any range of values therebetween. In some embodiments, heating of the nickel-rich cathode active material mixture is performed in an oxidizing atmosphere, an inert atmosphere, or a reducing atmosphere. In some embodiments, an oxidizing atmosphere is an atmosphere comprising oxygen, for example such as air or an oxygen rich atmosphere. In some embodiments, an oxygen rich atmosphere comprises at least 21 vol % oxygen, at least 23.5 vol % oxygen or at least 25 vol % oxygen. In some embodiments, an inert atmosphere is an atmosphere comprising helium, neon, argon, krypton, xenon, radon, nitrogen, or combinations thereof. In some embodiments, a reducing atmosphere is an atmosphere comprising hydrogen, carbon monoxide, hydrogen sulfide, or combinations thereof. In some embodiments, heating is performed for a duration of, of about, of at least, or at least about, 0, 1, 2, 4, 6, 8, 10, 20 or 30 hours, or any range of values therebetween.

### Energy Storage Device

The doped and/or coated nickel-rich cathode active materials may be used in the preparation of an electrode for an energy storage device. In some embodiments, an electrode film (e.g., doped and/or coated nickel-rich electrode film) comprises a doped and/or coated nickel-rich cathode active material. In some embodiments, an electrode comprises a current collector and the electrode film. In some embodiments, the electrode is a cathode electrode.

In some embodiments, an energy storage device includes an electrode as described herein. In some embodiments, the energy storage device comprises a separator, an anode electrode, a cathode electrode, and a housing, wherein the separator, anode electrode and cathode electrode are disposed within the housing and the separator is positioned between the anode and cathode electrodes. In some embodiments, an energy storage device is formed by placing a separator, an anode electrode and the cathode electrode within a housing, wherein the separator is placed between the anode electrode and the cathode electrode. In some embodiments, the energy storage device is a battery. In some embodiments, the energy storage device is a lithium-ion battery.

### EXAMPLES

Example embodiments of the present disclosure, including processes, materials and/or resultant products, are described in the following examples.

### Example 1—Calcium-Doped Nickel-Rich Cathode Active Materials

A calcium-doped and a doped-control nickel-rich cathode active material were prepared. A nickel-rich Ni_{0.98}Al_{0.02}(OH)₂ precursor material was mixed with 0.125-1.00 mol. % ZrO₂ and 0.25 mol. % Ca(OH)z dopant material to form a calcium-doped nickel-rich precursor mixture. Additionally, a doped-control nickel-rich precursor mixture was prepared by mixing Ni_{0.98}Al_{0.02}(OH)₂ precursor material with 0.125-1.00 mol. % ZrO₂ dopant material. A lithium source, LiOH, was mixed with the calcium-doped nickel-rich precursor mixture and the doped-control nickel rich precursor mixture at a molar ratio of lithium:nickel of 1.03:1 to form a lithiated calcium-doped nickel-rich precursor mixture and a lithiated doped-control nickel-rich precursor mixture. The lithiated calcium-doped nickel-rich precursor mixture and the lithiated doped-control nickel-rich precursor mixture were heated at 670-700° C. in oxygen for 3-8 hours. The heated lithiated calcium-doped nickel-rich precursor mixture and heated lithiated doped-control nickel-rich precursor were ground and sieved to produce a calcium-doped nickel-rich cathode active material and a doped-control nickel-rich cathode active material.

The produced calcium-doped nickel-rich cathode active material had a formula of LiₐNi_{b}Al_{c}Ca_{d}ZrₑO₂, wherein a is from about 0.99 to about 1, b is from about 0.96 to about 0.97, c is from about 0.015 to about 0.025, d is from about 0.0015 to about 0.0035, e is from about 0.003 to about 0.007. The values of a, b, c, d and e created a neutrally charged dopant material.

### Example 2—Sulfur-Coated Nickel-Rich Cathode Active Materials

Sulfur-coated and coated-control nickel-rich cathode active materials were prepared. A doped nickel-rich cathode active material was washed with water, then a solid-liquid separation was performed on the washed nickel-rich cathode active material. The washed nickel-rich cathode active material was mixed with a NaAlO₂ solution, and subsequently mixed with an NH₄W solution to form a metal coated nickel-rich cathode active material. A portion of the metal coated nickel-rich cathode active material was set aside and heated at 200-250° C. in oxygen for 3-8 hours to form the coated-control nickel-rich cathode active material.

The metal coated nickel-rich cathode active material was mixed with 0.1-0.5 mol. % of a DMS dry powder and heated at 200-250° C. in oxygen for 3-8 hours to form the sulfur-coated nickel-rich cathode active materials.

### Example 3—XRD Peak Widths

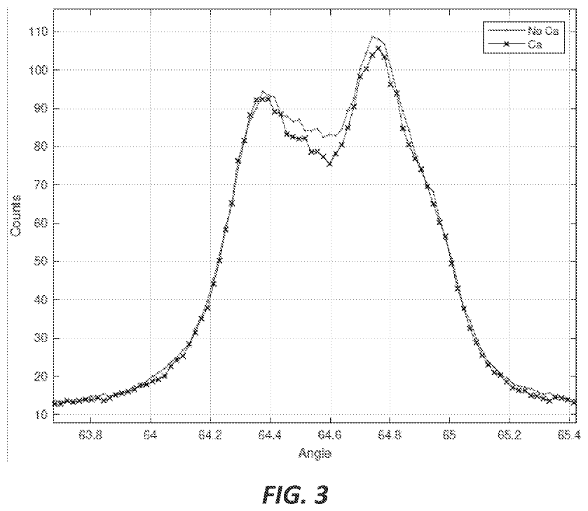

FIG. 3 is an XRD pattern plot comparing the lattice structure of a calcium-doped nickel-rich cathode active material to the doped-control cathode active material. The data provided in FIG. 3 is further summarized in Table 1 below. As can be seen in FIG. 3 and Table 1, calcium-doped nickel-rich cathode active materials (labeled “Ca”) were found to have narrower x-ray diffraction peak widths than the doped-control nickel-rich cathode active materials (labeled “No Ca”). This indicates reduced lithium and nickel mixing in the crystal lattice of the calcium-doped nickel-rich cathode active materials.

TABLE 1

| Details | a | c | (003) Peak Width | Li/Ni Mixing |
|---|---|---|---|---|
| Calcium-doped | 2.875 | 14.207 | 0.09 | 1.7 |
| Doped-control | 2.876 | 14.205 | 0.105 | 2.2 |

### Example 4—Electrochemical Cell Preparation and Testing

Half cells comprising calcium-doped and doped-control and/or sulfur-coated and coated-control nickel-rich cathode active materials were prepared and tested. Doped and/or coated cathode active materials were prepared utilizing similar processes to those described in Examples 1 and 2. Cathode electrodes were prepared by providing the doped and coated cathode active materials, and the materials were mixed with polyvinylidene difluoride (PVDF) and Super-S carbon black at a ratio of 85:10:5 w. % in N-methyl-2-pyrrolidone (NMP) to form a slurry. The slurry was cast onto a piece of aluminum foil and then dried in an oven at 120° C. for 3 hours. The dried mixture was then calendered at a pressure of 2000 atm to form a bulk electrode material with a loading of 10.51 mg/cm². 1.2 cm coin cell electrodes were punched from the bulk electrode material and the coin cell electrodes were dried under vacuum at 120° C. for 14 hours. Coin cells were fabricated in an argon-filled glove box by stacking a coin cell electrode, a first separator, a second separator, and a lithium foil negative electrode.

Full cells (i.e., pouch cells) comprising calcium-doped and doped-control and/or sulfur-coated and coated-control nickel-rich cathode active materials were prepared and tested. Cathode electrodes for the full cells were prepared similarly to those prepared for the half cells. Full cells were prepared by stacking a cathode electrode, a separator, and an anode electrode together to form an electrode stack. The electrode stack was placed in a pouch which was filled with a lithium hexafluorophosphate electrolyte solution. As prepared, the full cells had an approximate capacity of 200 mAh. Galvanostatic charge and discharge cycling was performed using an Arbin battery testing system. The full cells were maintained at 40° C. during testing. The full cells were initially charged to 4.2 V at a constant rate of C/20 and then discharged to 2.5 V at a rate of C/20. Then the full cells were then cycled between 2.85-4.20 V at a constant rate of C/3.

### Example 5—Electrochemical Cells Including Calcium-Doped Nickel-Rich Cathode Active Materials

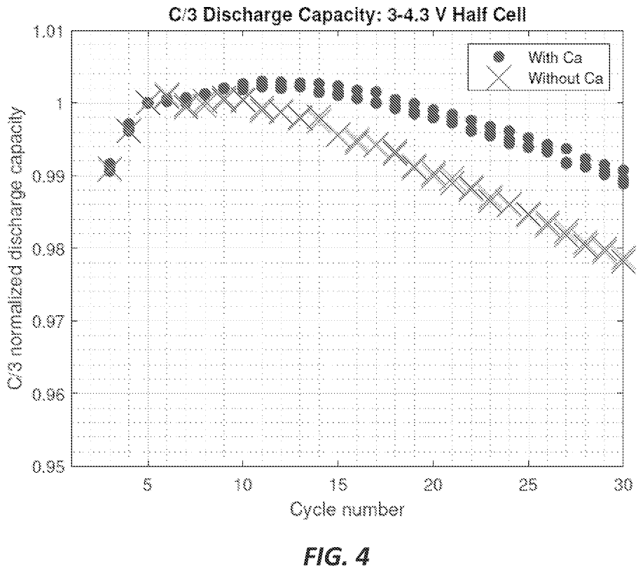

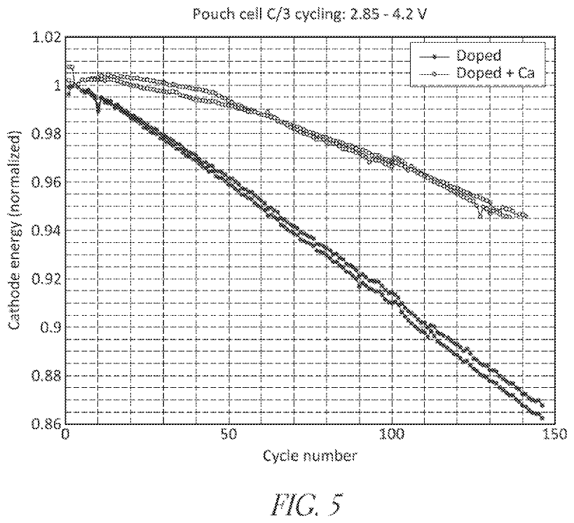

FIGS. 4 and 5 are plots showing the performance of half cells and full cells, respectively, comprising a calcium-doped nickel-rich cathode active material, as compared to electrochemical cells comprising a doped-control nickel rich cathode active material. As can be seen in FIGS. 4 and 5, the normalized discharge capacity of electrochemical cells comprising a calcium-doped nickel-rich cathode active material (labeled “With Ca”) demonstrated improved performances relative to cells comprising a doped-control nickel-rich cathode active material (labeled “Without Ca”).

### Example 6—Electrochemical Cells Including Sulfur-Coated Nickel-Rich Cathode Active Materials

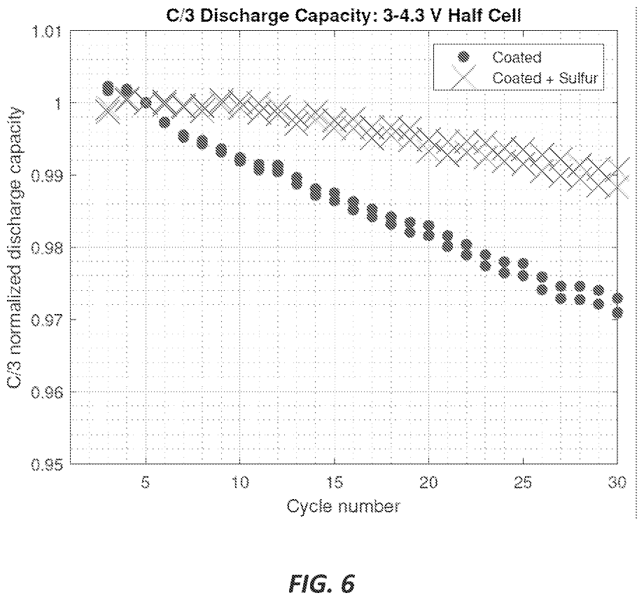

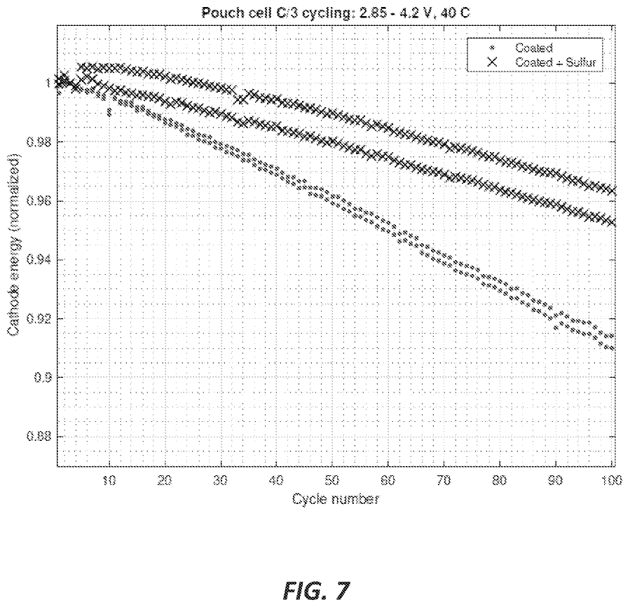

FIGS. 6 and 7 are plots showing the performance of half cells and full cells, respectively, comprising a sulfur-coated nickel-rich cathode active material (labeled “Coated+Sulfur”), as compared with electrochemical cells comprising a coated-control nickel-rich cathode active material (“Coated”). As can be seen in FIGS. 6 and 7, the normalized discharge capacity and normalized capacity retention, respectively, of electrochemical cells comprising a sulfur-coated nickel-rich cathode active material demonstrated improved performance relative to cells comprising a coated-control nickel-rich cathode active material.

### Example 7—Electrochemical Cells Including Either Tungsten-Coated or Molybdenum-Coated Nickel-Rich Cathode Active Materials

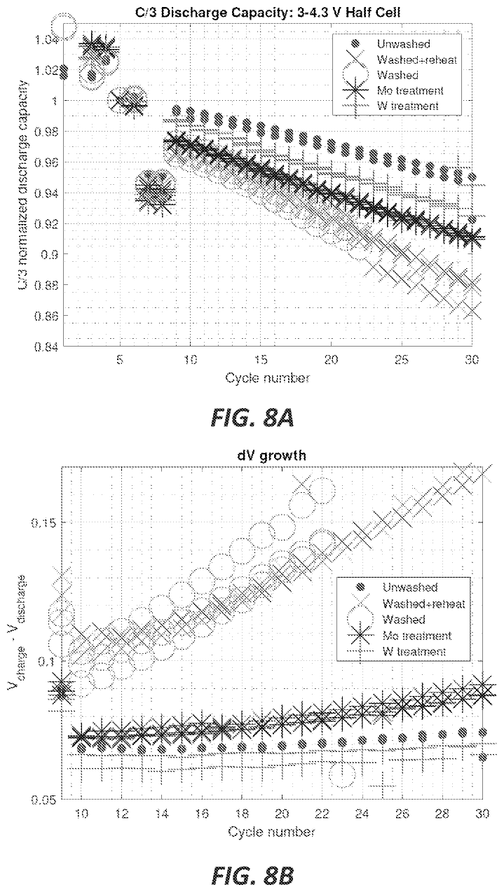

FIGS. 8A and 8B are plots showing the performance of half cells comprising a tungsten-coated nickel-rich cathode active material (labeled “W treatment”) and a molybdenum-coated nickel-rich cathode active material (labeled “Mo treatment”), as compared with cells comprising an unwashed non-coated nickel-rich cathode active material (labeled “Unwashed”), a washed non-coated nickel-rich cathode active material (labeled “Washed”), and a washed and reheated non-coated nickel-rich cathode active material (labeled “Washed+reheat”). As can be seen in FIGS. 8A and 8B, the discharge capacity and dV growth, respectively, of electrochemical cells comprising a tungsten-coated or molybdenum-coated nickel-rich cathode active material demonstrated improved performance relative to electrochemical cells comprising an unwashed non-coated nickel-rich cathode active material, a washed non-coated nickel-rich cathode active material, and a washed and reheated non-coated nickel-rich cathode active material.

### Example 8—Electrochemical Cells Including Sulfur-Coated and/or Calcium-Doped Active Materials

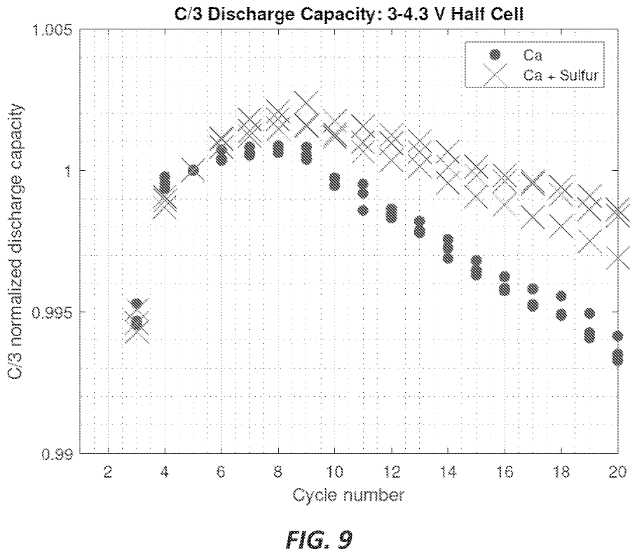

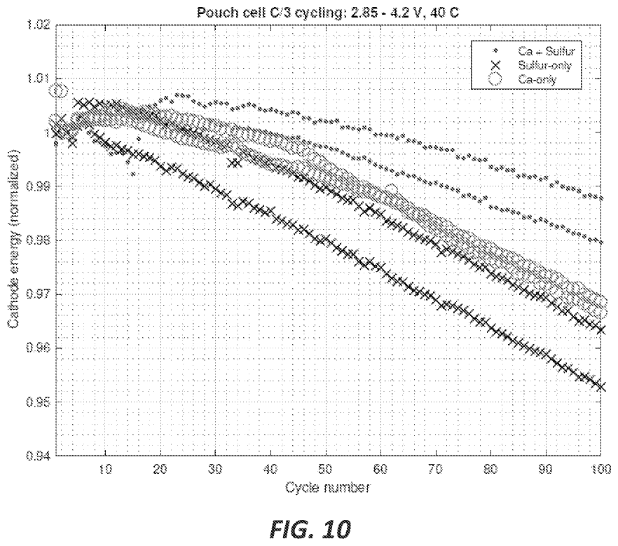

FIGS. 9 and 10 are plots showing the performance of half cells and full cells, respectively, comprising a DMS-coated (i.e. sulfur-coated) and calcium-doped nickel-rich cathode active material (labeled “Ca+Sulfur”), as compared to electrochemical cells comprising a DMS-coated nickel-rich cathode active material (labeled “Sulfur-only”) and calcium-doped nickel-rich cathode active material (“Ca-only”). As can be seen in FIGS. 9 and 10, the normalized discharge capacity and normalized capacity retention, respectively, of electrochemical cells comprising a sulfur-coated and calcium-doped nickel-rich cathode active material had improved performance relative to electrochemical cells comprising a calcium-doped nickel rich cathode active material and sulfur-coated nickel rich cathode active material.

### Example 9—Electrochemical Cells Including Cathode Active Materials with Either Aluminum or Zirconium Transition Metals

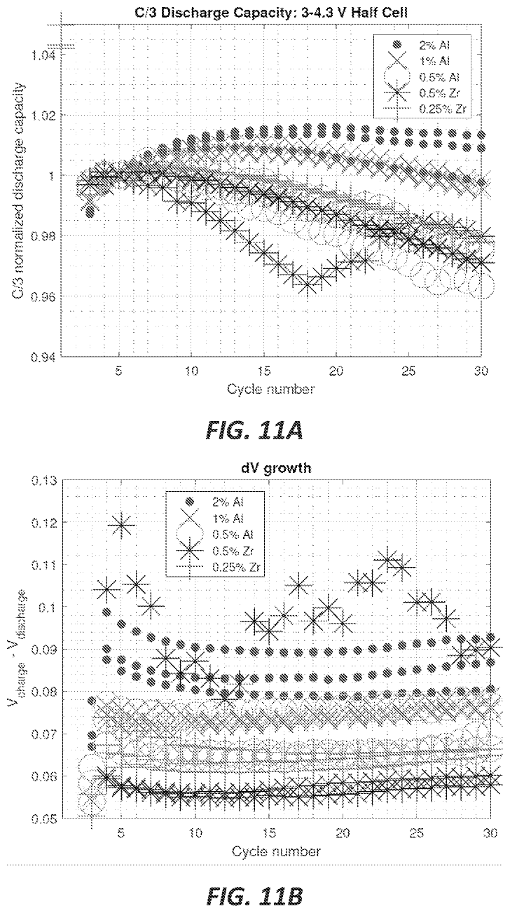

FIGS. 11A and 11B are plots showing the performance of half cells comprising cathode active materials comprising 2 mol. %, 1 mol. %, or 0.5 mol. % aluminum transition metal within the active material (labeled “2% Al”, “1% Al”, “0.5% Al” respectively), or alternatively 0.5 mol. % or 0.25 mol. % zirconium transition metal (labeled “0.5% Zr”, “0.25% Zr” respectively). As can be seen in FIGS. 11A and 11B, the normalized discharge capacity and average charge voltage—average discharge voltage growth, respectively, of electrochemical cells comprising nickel-rich cathode active material including an aluminum transition metal showed improved performances as transition metal mol. % were increased.

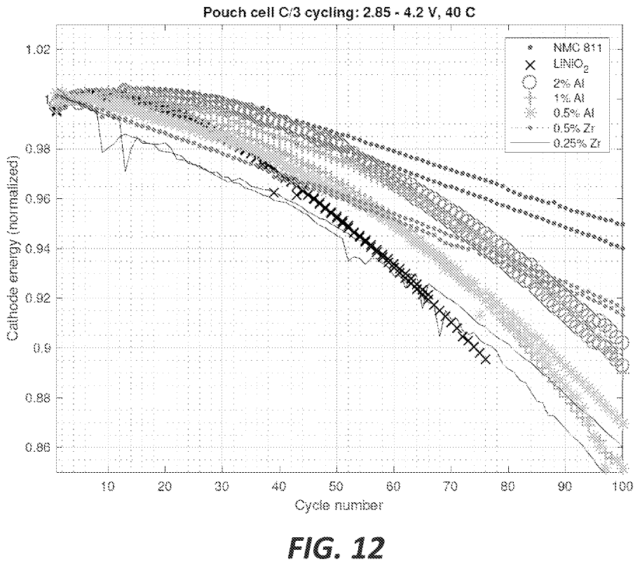

FIG. 12 is a plot showing the performance of full cells comprising cathode active materials comprising 2 mol. %, 1 mol. %, or 0.5 mol. % aluminum transition metal within the active material (labeled “2% Al”, “1% Al”, “0.5% Al” respectively), or alternatively 0.5 mol. % or 0.25 mol. % zirconium transition metal within the active material (labeled “0.5% Zr”, “0.25% Zr” respectively), as compared with electrochemical cells having a LiNi_{0.8}Co_{0.1}Mn_{0.1}O₂ (labeled “NMC 811”) cathode active material or a LiNiO₂ (labeled “LiNiO₂”) cathode active material. As can be seen in FIG. 12, electrochemical cells having a nickel-rich cathode active material with a zirconium transition metal included demonstrated improved lifetimes relative to electrochemical cells with NMC811 and LNO cathode active materials.

While certain embodiments have been described, these embodiments have been presented by way of example only and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the components for an energy storage system described herein can be provided separately, or integrated together (e.g., packaged together, or attached together) to form an energy storage system.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

1. A doped nickel-rich cathode active material, comprising a compound having the chemical formula:
LiNiₐTm_{b}M_{c}O₂;
wherein:
Tm is a transition metal element;
M is a dopant element;
a is a value of at least 0.9;
b is a value from 0.01 to 0.0995; and
c is a value from 0.005 to 0.02.

2. The material of claim 1, wherein the dopant element is selected from the group consisting of Ca, Mg, Zr, and combinations thereof.

3. The material of claim 1, wherein the dopant element is Zr and another element selected from the group consisting of Ca, Mg, and combinations thereof.

4. The material of claim 1, wherein the compound comprises an atomic amount of Zr of at least about 0.003.

5. The material of claim 1, wherein the transition metal element is selected from the group consisting of Al, Mn, Ti, Co, and combinations thereof.

6. The material of claim 1, wherein the transition metal element comprises Alₓ, wherein x is a value from 0.01 to 0.03.

7. The material of claim 1, wherein the transition metal element comprises Mn_{y}Co_{z}, wherein y is a value from 0 to 0.05, wherein z is a value from 0 to 0.05.

8. The material of claim 1, wherein the transition metal element comprises AlₓMn_{y}Co_{z}, wherein x is a value from 0.01 to 0.03, wherein y is a value from 0.01 to 0.05, wherein z is a value from 0.01 to 0.05.

9. The material of claim 1, further comprising a coating material disposed over the doped nickel-rich cathode active material.

10. The material of claim 9, wherein the coating material is selected from the group consisting of a sulfur compound, a metal compound, and combinations thereof.

11. An electrode film comprising the material of claim 1.

12. A nickel-rich cathode electrode comprising the electrode film of claim 11 disposed over a current collector.

13. An energy storage device, comprising:
the nickel-rich cathode electrode of claim 12;
a separator;
an anode electrode;
an electrolyte; and
a housing, wherein the nickel-rich cathode electrode, the separator, and the anode electrode are positioned within the housing.

14. The energy storage device of claim 13, wherein the energy storage device is a battery.

15. A coated nickel-rich cathode active material, comprising:
a nickel-rich cathode active material; and
a sulfur coating disposed over the nickel-rich cathode active material.

16. The material of claim 15, wherein the sulfur coating comprises a compound is selected from the group consisting of dimethyl sulfone, dimethyl sulfoxide, sulfur nanoparticles, sodium dodecyl sulfate, sodium sulfate, lithium sulfate, and combinations thereof.

17. The material of claim 15, further comprising a metal coating.

18. The material of claim 17, wherein the metal coating comprises an element selected from the group consisting of Al, W, Mo, and combinations thereof.

19. The material of claim 15, wherein the coating comprises a plurality of coating layers.

20. The material of claim 15, wherein the nickel-rich cathode active material comprises a dopant element.

21. A process of preparing the material of claim 1, comprising:
mixing a nickel-rich precursor, a dopant material, and a lithium source, to form a lithiated nickel-rich precursor mixture; and
heating the lithiated nickel-rich precursor mixture to form a doped nickel-rich cathode active material.

22. The process of claim 21, further comprising disposing a sulfur coating material over the doped nickel-rich cathode active material.

23. A process of preparing the material of claim 15, comprising:
mixing a nickel-rich cathode active material with a sulfur coating material, to from a nickel-rich cathode active material mixture, wherein the coating material is disposed over the nickel-rich cathode active material; and
heating the nickel-rich cathode active material mixture to form a coated nickel-rich cathode active material.

24. The process of claim 23, wherein the nickel-rich cathode active material further comprises a dopant element.
